(19) United States
(12) Patent Application Publication
(10) Pub. No.: US 2010/0017014 A1
(43) Pub. Date: Jan. 21, 2010

(54) APPARATUS FOR SEPARATING PLATE-SHAPED OBJECTS

(75) Inventor: Anton Schwetz, Ebersdorf (AT)

Correspondence Address: YOUNG & THOMPSON, 209 Madison Street, Suite 500, Alexandria, VA, 22314, US

(73) Assignee: BM-BATTERY MACHINES GMBH, EBERSDORF (AT)

(21) Appl. No.: 12/439,275

(22) PCT Filed: Dec. 6, 2007
(86) PCT No.: PCT/AT07/00551

§ 371 Date: Feb. 27, 2009

(30) Foreign Application Priority Data
Jan. 4, 2007 (AT) A 20/2007

(51) Int. Cl. B65G 59/04; G06F 7/00

(52) U.S. Cl. 700/213; 414/796.7

(57) ABSTRACT

A device for separating battery or accumulator plates has a supply conveyor (20) for plate stack (10), and a lifting device with two lifting tables (30 and 50) that can be actuated independently of one another to lift a plate stack (10) in the area of an unloading position. In the unloading position, a plate layer (40) is provided, which is equipped with a continuously rotating conveyor belt (41) equipped with suction heads (43). Another conveyor belt (70) is associated with the release-side end of the conveyor belt (41) of the plate layer (40), whereby the uptake-side end of the conveyor belt (70) overlaps with the release-side end of the conveyor belt (41) of the plate layer (40). The conveyor belt (41) of the plate layer (40) can pivot around an axis that is located in the area of the uptake-side end of the other conveyor belt (70) in such a way that its uptake-side end can be lifted from the plate stack (10) and brought closer to the latter.

The invention relates to a device with the features of the introductory part of claim 1.

Devices for separating plate-like objects, in particular battery or accumulator plates, from stacks of plate-like objects are known.

In prior proposals for devices for removing battery plates from stacks of battery plates (cf. AT 241 565 B, AT 329 124 B and AT 352 198 B), the battery plates are arranged in essentially vertical stacks, in which the plates are oriented essentially horizontally, and are removed from the stack from the bottom. This is problematic because of the weight of the stack that bears on the respective lowermost plate, since it happens that the battery plates adhere to one another and cannot easily be removed individually.

Devices have therefore also already been proposed in which stacks that are oriented horizontally and that stand essentially vertically are fed to the battery plates of a point of removal.

By way of example, reference is made to EP 0 141 806 B, EP 0 608 678 A and AT 405 824 B. In these known devices, the plates that are to be separated and that are essentially vertical are fed with a claw, which removes plates individually from the stack, to a separating device in horizontally oriented stacks. This produces an expensive kinematics of the claw, which removes plates individually from the stack and deposits them on a conveyor belt.

It is disadvantageous in these known devices that because of the complicated movements of the unloading claw, which should remove the plates individually from horizontal stacks, said devices are limited with respect to their performance capacity.

Devices for separating plate-like objects, in particular battery or accumulator plates, in which the plate-like objects are oriented horizontally and in which the objects are removed from the stack from above, are also known.

Devices of this design are known from DE 32 02 087 A, EP 0 445 496 A or WO 2006/005089 A.

In this case, devices that are known from DE 32 02 087 A and EP 0 445 496 A operate with conveyor belts that are equipped with suction devices and that in each case take up the uppermost object of a stack that consists of plate-like objects either directly from the stack (DE 32 02 087 A) or take up objects that are fed by horizontal movement (EP 0 445 496 A) and transport them to a downstream conveyor belt.

In WO 2006/005089 A, a device is described in which a device for removing individual objects from a stack, which deposits plate-like objects lifted from the stack onto a blade conveyor belt that is associated with it, is provided for lifting the respective uppermost plate-like object. From this blade conveyor belt, the plates are released to another conveyor that feeds plate-like objects for further processing to downstream stations, e.g., arrangements for brushing the tags, when battery or accumulator plates are involved.

All known devices, in particular those of EP 0 445 596 A or WO 2006/005089 A, operate satisfactorily per se, but do not fully meet heightened requirements with respect to always shorter clock cycles and a simplified and more reliable design.

The object of the invention is to indicate a device of the above-mentioned type, with which shorter clock cycles are possible when removing plate-like objects, in particular (lead) plates for batteries and accumulators, from stacks.

This object is achieved according to the invention with a device that has the features of claim 1.

Preferred and advantageous configurations of the invention are the subject of the subclaims.

Since, in the device according to the invention, the respective uppermost plate-like object is removed from a stack of essentially horizontal plate-like objects, which stack is oriented essentially vertically, a simple movement of the unloading claw (“plate layer”) is possible. As a result, when plate-like objects are separated from stacks of such plate-like objects and when the separated plate-like objects are delivered to conveyor devices, short clock cycles can be achieved.

In a preferred embodiment, the plate layer that is provided as an unloading claw is designed as a conveyor belt, on which two or more groups of suction devices are provided, which are subjected to underpressure for taking up plate-like objects, and remain subject to underpressure until the plate-like objects are released to a downstream conveyor.

In particular, the device according to the invention is suitable for the separation of battery or accumulator plates that are conveyed in stacks, whereby the separated plates can then be fed to another processing step, for example the brushes of the contact tags, and devices for jacketing battery or accumulator plates.

Other details, features and advantages of the device according to the invention follow from the description of a preferred embodiment, below, based on the drawings. Here:

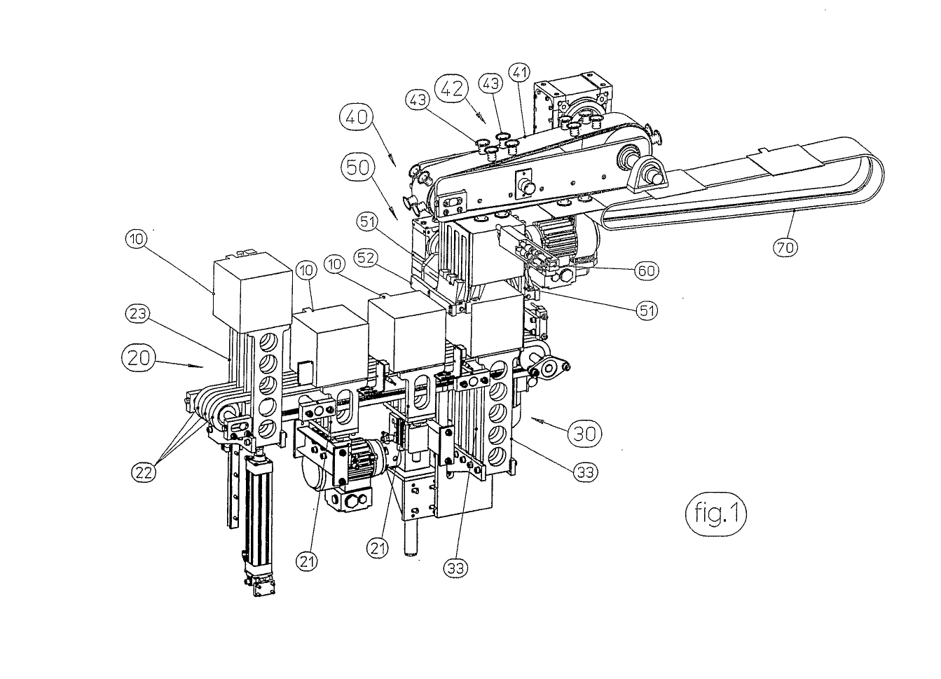

FIG. 1 shows, in schematic form, a device according to the invention with stacks or packets of (battery) plates, marked by symbols, in oblique view;

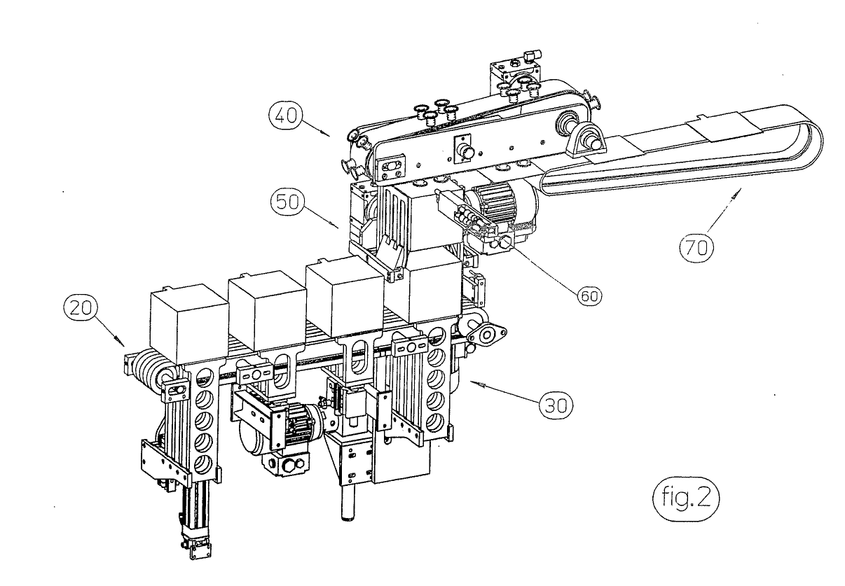

FIG. 2 shows the device from FIG. 1 in another operational position;

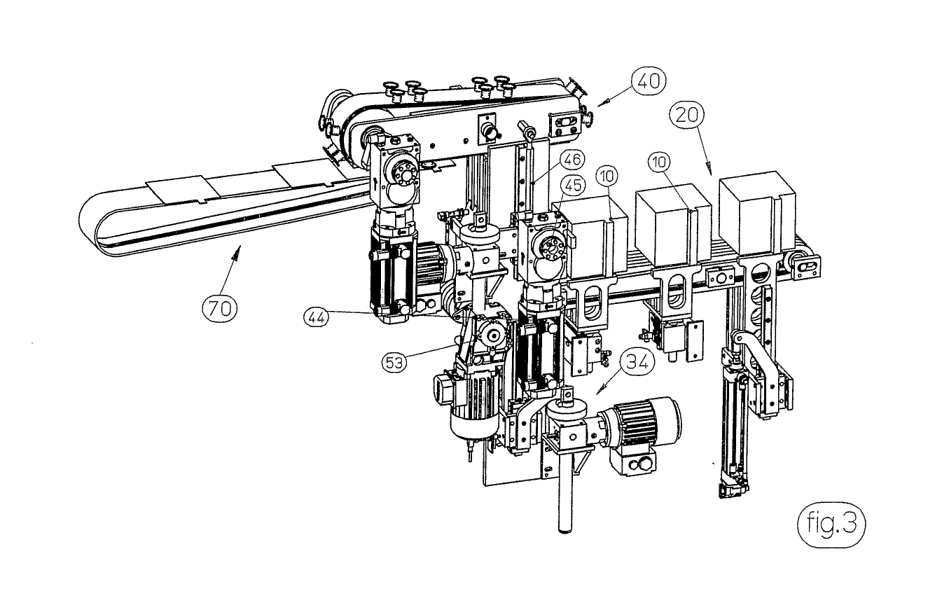

FIG. 3 shows the device of FIGS. 1 and 2 seen from the other side;

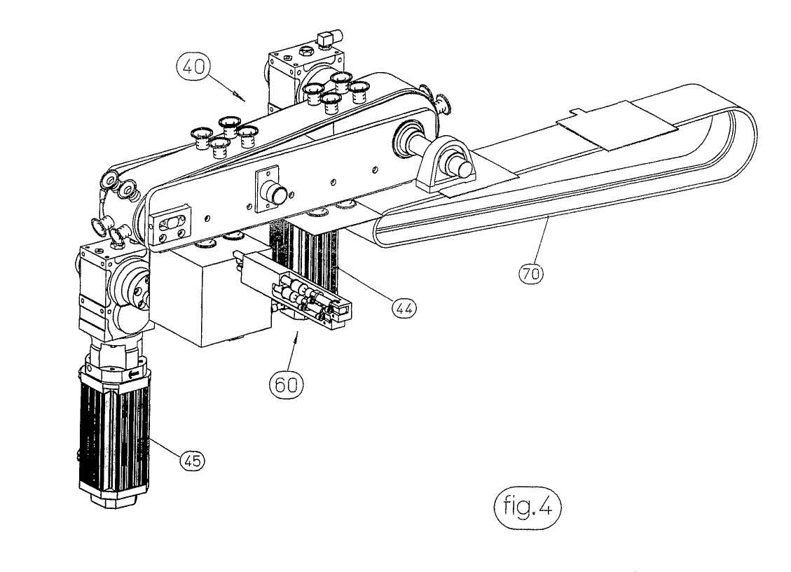

FIG. 4 shows a detail of the device in the area of the plate layer;

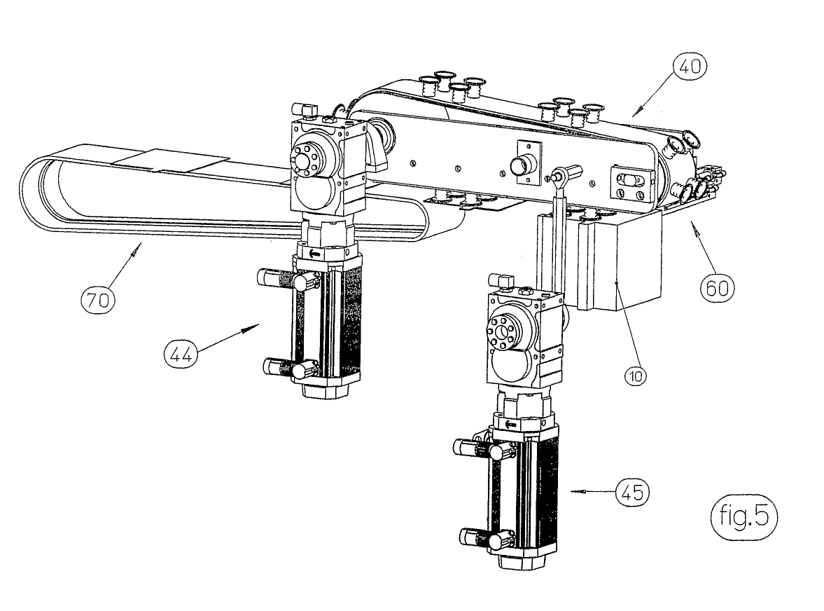

FIG. 5 shows the detail of the device from FIG. 4 seen from the other side; and

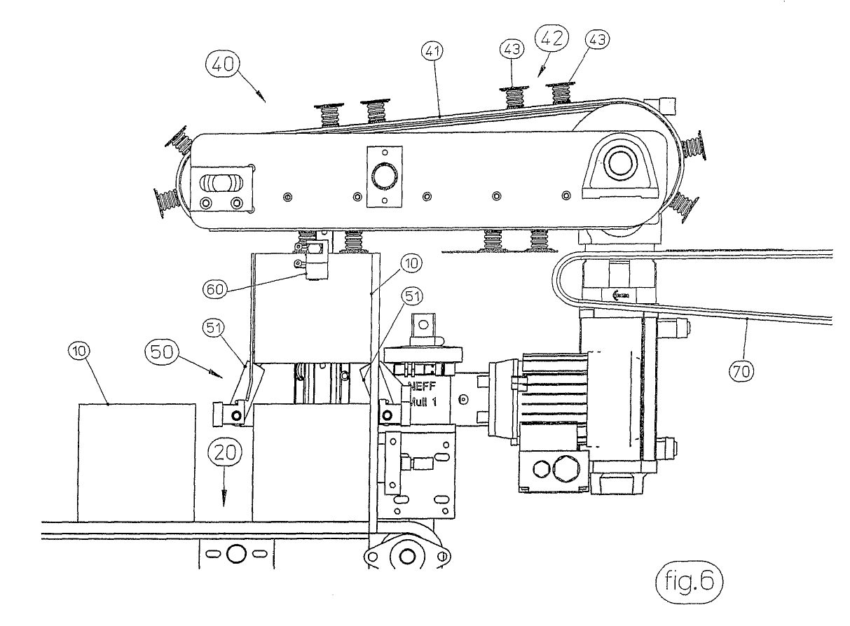

FIG. 6 shows the detail of the device from FIG. 4 in another side view.

Plate stacks 10 (heights of 4″ to 6″) are positioned manually or automatically on a horizontal conveyor 20 (preferably a chain conveyor device). On the horizontal conveyor 20, for example, pneumatically operated removal units 21 that can lift plate stacks 10 off of the horizontal conveyor 20 are positioned in the division of the stack intervals. Thus, it is ensured that on each division space, a plate stack 10 is present and the respective plate stack 10 is conveyed to the lifting table 30 (below) of a lifting device as quickly as possible.

The lifting table 30 conveys (lifts) the plate stack 10 vertically upward until a sensor recognizes the upper edge of the plate stack 10 and terminates the movement of the lifting table 30. Plates are now removed individually from the plate stack 10 by a plate layer 40, e.g., a vacuum-suction device plate layer (functional description further below). In this case, the lifting table 30 conveys the remaining plate stack 10 so that the upper edge of the plate stack 10 always has the same position, in which the plate layer 40 can remove the respective uppermost plate from a plate stack 10.

If a plate stack 10 is processed to the extent that its lower edge has reached a certain position by the lifting of the plate stack 10 in steps, two spring-loaded holding flaps 51, opposite one another, of another lifting table 50 (above) fold inward. Sensors that query the pivoting position of the holding flaps 51 now operate the upper lifting table 50, which thus takes over the function of resetting the plate stack upper edge by continued lifting in steps of the plate stack 10. Meanwhile, the lower lifting table 30 can run downward, can take up the next plate stack 10 from the horizontal conveyor 20 and convey the latter upward.

When the upper edge of the plate stack 10 that is conveyed from the lower lifting table 30 approaches the holding flaps 51 on the upper lifting table 50, the plate stack 10 with its uppermost plate presses the holding flaps 51 outward, and the upper plate stack 10 settles onto the conveyed plate stack 10. The sensors, which query the position of the holding flaps 51, now operate the lifting table 30, which thus takes over the function of resetting the plate stack upper edge by lifting the plate stack 10. The lifting table 50 runs downward into its stand-by position. This movement sequence now starts afresh.

To ensure the exact removal of individual plates from the plate stack 10, a plate separation 60 is used. The latter is described further below.

The plate layer 40 (“unloading claw”) is equipped with a circumferential belt 41 (conveyor) which is equipped with groups 42 (suction heads) of preferably four suction devices 43 each. The movement and the pivoting movement of the belt 41 is preferably produced with a servo drive (motors 44, 45) in each case. The plate layer 40 can pivot back and forth by a drive 45, between one position, in which it is brought toward the upper end of the plate stack 10, which is worked into a straight line, with its ends that lie above the lifting tables 30 and 50, and one position in which it is removed from the upper end of the plate stack 10. First, the plate layer 40 (its belt 41) pivots downward (about 15 mm in the area of the plate stack 10), takes up a plate with a group 42 that consists of vacuum-loaded suction devices 43, and pivots upward. During the upward pivoting, the feed (drive 44) starts, and the belt 41 of the plate layer 40 further transports the plate around a division of the plate layer 40. Then, the belt 41 of the plate layer 40 stops again. Now, the plate is located just in front of the end of the conveyor belt 70 on the uptake side (“clamping belt”) of a downstream conveying device. The uptake-side end of the conveyor belt 70 is located below the release-side end of the belt 41 of the plate layer 40. The plate layer 40 pivots downward again, takes up the next plate from the plate stack 10, pivots upward and starts the feed once again. The first plate that is removed is now delivered to the conveyor belt 70, whereby the feed movements of the belt 41 of the plate layer 40 and that of the conveyor belt 70 are synchronous to one another with respect to time and extent in the delivery of the plate. The belt 41 of the plate layer 40 stops and pivots with its uptake-side end downward to the plate stack 10 to take up the next plate from the plate stack 10 only once the suction device 43 of the group 42 has completely released the plate that is delivered to the conveyor belt 70.

The conveyor belt 70 runs synchronously with the machine clock and transports plates to or through additional processing stations (double plate detection, tag brushes, etc.). The pivoting movements and the feed of the plate layer 40 can overlap for the purpose of saving time.

The embodiment of a device according to the invention that is generally explained above is explained in further detail below:

A device according to the invention, as it is shown by way of example in FIGS. 1 to 3, has the conveyor 20 (horizontal conveyor) for conveying stacks 10 of plates, in particular positive and/or negative (lead) plates for batteries and accumulators, and a device 30 (lower lifting table) that is arranged following this conveyor belt 20 (stack feeder) to lift stacks 10 to a separating station with the plate layer 40 and the device 60 for separating plates. Following the separation station, the conveyor belt 70 of the other conveying device is provided, with which the plates that are separated in the separating station can be fed to other system parts (not shown).

The individual components of the device are described below:

The horizontal conveyor 20 (stack feeder) is, for example, a strap conveyor or chain conveyor with three conveyor elements 22 (straps or chains) in the embodiment, on which, in the area of the end, lying to the left in FIG. 1, of the upper ends of the conveying elements 22, which are moved toward the right in FIG. 1, stacks 10 of plates are packed closely by any device 23. Two lifting devices 21 are associated with the upper ends of the conveying elements 22 of the horizontal conveyor 20 and can remove the stacks 10, located on the horizontal conveyor 20, from the conveying elements 22 to stop the stacks 10, so that the latter can be fed to the lifting device 30 (lifting table, below), which is located on the release-side end of the horizontal conveyor 20, in an orderly manner and spaced some distance apart.

The lifting device has a lower lifting table 30, which is arranged in its lower starting position in a lower range, i.e., essentially at the upper ends of the conveying elements 22 of the horizontal conveyor 20. In the embodiment, this lower lifting table 30 has five lifting elements 33, which can be lifted upward between or laterally in addition to the conveying elements 22 (chains, belts or straps) of the horizontal conveyor 20.

The second, upper lifting table 50 of the lifting device 50 is located in the upper area of the lifting device. The second lifting table 50 comprises pivotable holding flaps 51, mounted on arms 52, which, as indicated in FIG. 1, pivot inward under spring loading as soon as a plate packet 10 from the lifting table 30 has been lifted so far that the uppermost plate exposes the holding flaps 51. As soon as this is happening, the plate stack 10 is further lifted in cycles from the upper lifting table 50, as is explained in still more detail below. In the meantime, the lower lifting table 30 can again be moved downward, pick up another plate packet 10 from it, and be lifted until it rests on the previously lifted plate stack 10 that is held on the upper lifting table 50 while the holding flaps 51 of the second lifting arrangement 50 pivot away from the bottom.

The control of the movements of the lower lifting table 30 and the upper lifting table 50 is carried out using sensors, which detect the pivoting position of the holding flaps 51.

In this way, stacks 10 in the lifting device can be lifted from the lower lifting table 30 until the uppermost plate is located in the unloading position. When a portion of the plates has been removed from the stack 10, the latter thus has been partially processed, the holding flaps 51 of the upper lifting table 50 pivot inward and hold the partially processed stack 10 there, so that the lower lifting table 30 can be lowered and the stack 10, which is now smaller, is picked up from the upper lifting table 50 and can be further lifted from the latter in steps in the direction of the plate layer 40 of the separating station.

By the interaction of the lower lifting table 30 and the holding flaps 50, which can pivot back and forth in the lifting path, of the upper lifting table 50, which can also be lifted upward, a continuous feeding of plates in the unloading position of the separating station is possible.

In the upper end of the lifted plate stack 10, the continuous belt 41 that is equipped with suction devices 43 is arranged as a plate layer 40. The continuous belt 41 that is equipped with suction devices 43 is guided into a component that can pivot around an axis that is located at a distance from the stack 10. To pivot the belt 41 that is equipped with the suction devices 43 and that is used as a plate layer 40, an eccentric drive 45 is provided, which is coupled using a connecting rod 46 to the end of the support for the conveyor belt 41.

In the embodiment that is shown, several groups 42 that are some distance apart are provided on the belt 41 of the plate layer 40 in preferably four suction devices 43 each, which are loaded with underpressure via a housing 47, when they move in the area between the upper end of the stack 10 and the beginning of the other conveyor belt 70.

As FIG. 6, in particular, shows, the mutual arrangement of the belt 41 of the plate layer 40 that is equipped with the suction devices 43, on the one hand, and the conveyor belt 70, on the other hand, are selected such that a plate is clamped for a short time by the suction devices 43 and the uptake-side end of the conveyor belt 70—both move at identical speed—so that when being put on the uptake-side end of the conveyor belt 70, a plate is not free, but rather is delivered in a defined manner. Thus, the plate that is to be delivered is briefly clamped between the suction devices 43 of the belt 41 of the plate layer 40, on the one hand, and on the uptake-side end of the conveyor belt 70, on the other hand. It is thus ensured that plates are not delivered in a lopsided or uncontrolled manner to the conveyor belt 70.

For the actuation of the lower lifting table 30, a lift-spindle drive that is driven by a servo motor is provided. Also, for the lifting table 50 with the holding flaps 51, a lift-spindle drive 53 is provided.

For the movements of the lifting tables 30 and 50 of the lifting device, continuous-link drives (chains, straps, toothed belts, parts, etc.) can also be provided, whereby the lifting tables 30 and 50 are coupled to the continuous links that are associated with them in each case. For the movement of the continuous links of both drives, motors, e.g., servo motors, can be provided.

To ensure that only one plate is lifted from the stack 10 by the plate layer 40 in each case, a device for plate separation 60 is associated with the separating station. This plate separation 60 has a finger that can be moved back and forth, and a spring that also can be moved back and forth and that is located under the finger at a distance that is equal to the plate thickness.

A stack 10 is lifted either from the lower lifting table 30 or from the upper lifting table 50 with the holding flaps 51 so far that the uppermost plate rests from the bottom on the extended finger of the plate separation 60. As soon as this has taken place, the spring is extended and penetrates the gap between the uppermost and the next lower plate, so that the upper plate is reliably separated from the plates located thereunder and is lifted from the plate layer 40 using its suction heads 43 and, as described, can be laid down on the conveyor belt 70.

In summary, an embodiment can be described as follows:

A device for separating battery or accumulator plates has a supply conveyor 20 for plate stack 10, and a lifting device with two lifting tables 30 and 50 that can be actuated independently of one another to lift a plate stack 10 into the area of an unloading position. In the unloading position, a plate layer 40 is provided, which is equipped with a continuously rotating conveyor belt 41 that is equipped with suction heads 43. Another conveyor belt 70 is associated with the release-side end of the conveyor belt 41 of the plate layer 40, whereby the uptake-side end of the conveyor belt 70 overlaps with the release-side end of the conveyor belt 41 of the plate layer 40. The conveyor belt 41 of the plate layer 40 can pivot around an axis that is located in the area of the uptake-side end of the other conveyor belt 70 in such a way that its uptake-side end can be lifted from the plate stack 10 and brought closer to the latter. In this case, a plate is clamped to the belt 41 of the plate layer 40 during delivery of plate layers 40 to the other conveyor belt 70 between the other conveyor belt 70 and the suction devices, so that a controlled release is possible. In addition, a plate separation device 60 is associated with the upper end of a stack 10, which is processed by the removal of plates, which ensures that in each case, only the uppermost plate is lifted.

1. Device for separating plate-like objects, in particular battery or accumulator plates, whereby the respective uppermost plate-like object is removed from a stack (10) of essentially horizontal plate-like objects, which stack is oriented essentially vertically, and settles at another location, with a plate layer (40), which is designed as an elongated conveyor (41), which is mounted so as to pivot on its release-side end around a horizontal axis and can be moved back and forth on its uptake end that is associated with the stack (10) between an upper conveying position and a lower removal position, and with a vertically movable lifting device (30, 50), with which stacks (10) can be lifted at the uptake end of the plate layer (40) during the gradual removal of plate-like objects from the stack (10), characterized in that the release-side end of the conveyor (41) of the plate layer (40) is arranged to overlap with another conveying device (70) for the transport of separated plate-like objects.

2. Device according to claim 1, wherein the other conveying device (70) is a conveyor belt that has at least one continuously rotating conveyor link.

3. Device according to claim 1, wherein a plate-like object between the conveyor (41) of the plate layer (40) and the synchronously moved additional conveyors (70) is clamped at the time of its delivery from the conveyor (41) to the other conveyors (70).

4. Device according to one of claims 1, wherein the first conveyor (41), which removes the plate-like objects individually from the stack (10), has a conveyor belt (41) that is equipped with suction devices (43) that are located in groups (42).

5. Device according to claim 1, wherein an eccentric drive (45, 46) is provided for pivoting the uptake-side end of the conveyor (41).

6. Device according to claim 5, wherein the eccentric drive is driven by a servo motor (45), which is coupled by means of a connecting rod (46) to the free end of the conveyor (41).

7. Device according to claim 1, wherein the drive (44) of the conveyor (41) is set up for an intermittent drive of the conveyor (41), in particular its conveyor belt.

8. Device according to claim 1, wherein the conveyor (41) can be shut down after its uptake-side end is lowered in the direction of the uppermost plate of a stack (10).

9. Device according to claim 1, wherein the lifting device has two lifting tables (30, 50) that are located over one another.

10. Device according to claim 9, wherein the lower lifting table (30) can be lifted essentially vertically.

11. Device according to claim 9, wherein the upper lifting table (50) can be lifted essentially vertically.

12. Device according to claim 9, wherein the lower lifting table (30) has lifting elements (33) that can be lifted from the bottom up to the lowermost plate of a stack (10).

13. Device according to claim 12, wherein the lifting elements (33) of the lower lifting table (30) are located between or beside conveying elements (22) of a supply conveyor (20) for plate stack (10) in the lifting device (30, 50).

14. Device according to claim 9, wherein the upper lifting table (50) has spring-loaded pivoting flaps (51), which can be applied from the bottom to two opposite edges of a lowermost plate-like object of a stack (10).

15. Device according to claim 14, wherein the pivoting flaps (51) are spring-loaded in their position that engages from below a stack (10) in the area of the lowermost plate-like object.

16. Device according to claim 14, wherein sensors are provided that detect the pivoting position of the pivoting flaps (51) and issue corresponding signals for the actuation of the lifting tables (30 and 50).

17. Device according to claim 16, wherein in the case where pivoted pivoting flaps (51) engage a stack (10) from below, the upper lifting table (50) is controlled in terms of the lifting of a stack (10).

18. Device according to claim 1, wherein the conveyor (41) of the plate layer (40) can be driven intermittently.

19. Device according to claim 1, wherein the conveyor belt (41) of the conveyor of the plate layer (40) and the conveyer belt of the second conveyor (70) can be driven synchronously.

20. Device according to claim 1, wherein the conveyor (41) of the plate layer (40) and the other conveyor (70) are brought close to one another in the area of their overlapping ends when a plate is delivered, by the conveyor belt of the conveyor (41) being pivoted with its free end downward.
